(19) United States
(12) Patent Application Publication
(10) Pub. No.: US 2004/0267565 A1
(43) Pub. Date: Dec. 30, 2004

(54) Interactive system for tracking and improving health and well-being of users by targeted coaching

(76) Inventor: James A. Grube, Leonardtown, MD (US)

Correspondence Address: ROYAL W. CRAIG, SUITE 153, 10 NORTH CALVERT STREET, BALTIMORE, MD, 21202, US

(21) Appl. No.: 10/739,869

(22) Filed: Dec. 17, 2003

Related U.S. Application Data
(60) Provisional application No. 60/434,228, filed on Dec. 17, 2002.

(51) Int. Cl. G06F 17/60

(52) U.S. Cl. 705/2

(57) ABSTRACT

A method for expert health coaching of individuals to improve their health, fitness and wellness through interactive Internet access which provides the user with an ongoing interactive coaching health assessment through selected health fitness weighted criteria and individually tailored feedback. Online prompts are presented to the user to complete a daily questionnaire on a variety of particularly defined health behaviors, including exercise, nutrition, sleep habits, and stress management. The data from the daily questionnaire are captured in a database and a daily score is calculated based on the input and weighted criteria. A coach is assigned to each individual and the personally assigned coach tracks the assigned individuals' progress daily via the coaching management module. The coach emails the assigned individuals with positive reinforcement, pats on the back or friendly prompts to do better, as appropriate.

### CROSS-REFERENCE TO RELATED APPLICATIONS

The present application derives priority from U.S. Provisional Patent Application 60/434,228 filed: Dec. 17, 2002.

### BACKGROUND OF THE INVENTION

1. Field of the Invention

The present invention relates to online portals for interactive health services and, more particularly, to a method for interactive health assessment and tracking through weighted criteria, and for improving health, fitness and well-being by administering individually tailored feedback through personally-assigned coaches over the Internet, in accordance with the present invention.

2. Description of the Background

It has long been known that effective behavior modification requires frequent assessment with timely feedback to the user. Software programs and the internet have been shown to be effective media for delivery of behavior modification programming. For example, U.S. Pat. No. 6,039,688 to Douglas et al. discloses a therapeutic behavior modification program, compliance monitoring and feedback system. The therapeutic behavior modification program includes a series of milestones for an individual to achieve lifestyle changes necessary to maintain his or her health or recover from ailments or medical procedures. The system monitors the individual's compliance with the program by periodically promoting the individual to enter health-related data, then correlates the individual's entered data with the milestones to generate compliance data.

U.S. Pat. No. 6,338,628 to Smith shows an online personal training and development delivery system that determines an individual's strengths and weaknesses and automatically provides training and development exercises.

U.S. Pat. No. 6,269,339 to Silver shows a system for developing a customized wellness plan whereby the user's wellness is measured by his or her physiological age. The system also provides a means by which a user can learn about personalized wellness options based on a combination of wellness factors and constraints input by the user and available health information, and a means whereby the user can monitor personal progress in improving wellness.

U.S. patent application No. 20020082144 to Pfeffer et al. shows a fitness triage system whereby exercise information is delivered to users based on the level of potential risk and other considerations as a result of an individual's answers to questions concerning key health risk factors, conditions and habits.

In addition, the 360° Performance Feedback System website at http://www.allenbaugh.com/coaching/360.htm assesses employee skills through an interactive website, makes targeted recommendations for improvements and provides online action planning tools to support coaching and employee development. Another website, the Nutricise website at http://www.nutricise.com/newsite/t_meeting.html, stresses personal contact from a Nutricise nutritionist who works with the customer for the duration of the program and serves as a personal weight loss guide.

A weight loss study was conducted at Brown University and the results were published in the Article, “Using Internet Technology to Deliver a Behavioral Weight Loss Program”, JAMA Mar. 7, 2001—Vol. 285, No. 9. The objective of the study was to determine whether a structured Internet behavioral weight loss program (with user feedback) produces greater weight loss than a weight loss education Web site (with no user feedback).

However, none of the foregoing or any other known prior art teaches an effective online implementation that approximates the approach that a good personal trainer would take, e.g., a method for interactive health assessment and tracking using a comprehensive health, lifestyle and fitness questionnaire with weighted ranking via weighted criteria, followed by a coordinated program for improving health, fitness and well-being by a personalized coach management including a combination of individually tailored feedback and group-feedback.

In light of the foregoing, it would be of great advantage to create an online interactive system to help individuals improve their health, fitness, and wellness, by prompting the user for input of health behaviors, building a database with the input, calculating each individual's score on a daily realtime basis, tracking each individual's progress, providing feedback by a personally assigned coach and providing interactive personal questions and answers.

### SUMMARY OF THE INVENTION

It is therefore an object of the present invention to provide an online interactive system to help individuals improve their health, fitness and wellness.

It is another object of the present invention to provide an online interactive system that helps companies to contain healthcare costs, increase employee productivity, and improve employee retention.

It is yet another object to provide an online interactive system that generates electronic prompts for user input of comprehensive personal health criteria.

It is still another object to provide an online interactive system that builds a database from the user input.

It is yet another object to provide an online interactive system that calculates each individual's daily score based on the input and weighted criteria.

It is yet another object to provide an online interactive system that tracks an individual's progress by a personally assigned coach, providing feedback to the user.

It is yet another object to provide an online interactive system that includes a coaching management function that allows coaches to effectively manage multiple customers.

It is still another object to provide an online interactive system that includes interactive communication between the individual member and the assigned coach.

It is yet another object to provide an online interactive system that is simple and easy to use.

It is still another object to provide an online interactive system that is a quick efficient tool in which the user has confidence.

These and other objects are accomplished by providing online prompts to the user to complete a daily questionnaire on a variety of health behaviors, including exercise, nutrition, sleep habits, and stress management. The data from the daily questionnaire are captured in a database and a daily score is calculated based on the input and weighted criteria. A coach is assigned to each individual and the personally assigned coach tracks the assigned individuals' progress daily via the coaching management module. The coach emails the assigned individuals with positive reinforcement, pats on the back or friendly prompts to do better, as appropriate.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flow diagram of the core method for interactive health assessment and tracking through weighted criteria, and for improving health, fitness and well-being by administering individually tailored feedback through personally-assigned coaches over the Internet, in accordance with the present invention.

FIG. 2 is a screen print of an exemplary login screen.

FIG. 3 is a screen print of an exemplary first screen in a series of registration screens.

FIG. 3A is a screen print of an exemplary buyer application form.

FIG. 3B is a screen print of an exemplary terms and conditions screen.

FIG. 3C is a screen print of an exemplary payment screen.

FIG. 3D is a screen print of an exemplary baseline questionnaire.

FIG. 3E is a screen print of an exemplary stage of change screen.

FIG. 3F is a screen print of an exemplary primary goal screen.

FIG. 3G is a screen print of an exemplary pace input screen.

FIG. 3H is a screen print of an exemplary registration confirmation screen.

FIG. 3I is a screen print of an exemplary “How Life Practice Works” screen.

FIG. 4 is an example of the daily input questionnaire.

FIG. 5 is an illustration of the user's Daily Results.

FIG. 6 is a flow diagram of the Coaches Console according to the present invention.

### DETAILED DESCRIPTION OF THE PREFERRED EMBODIMENTS

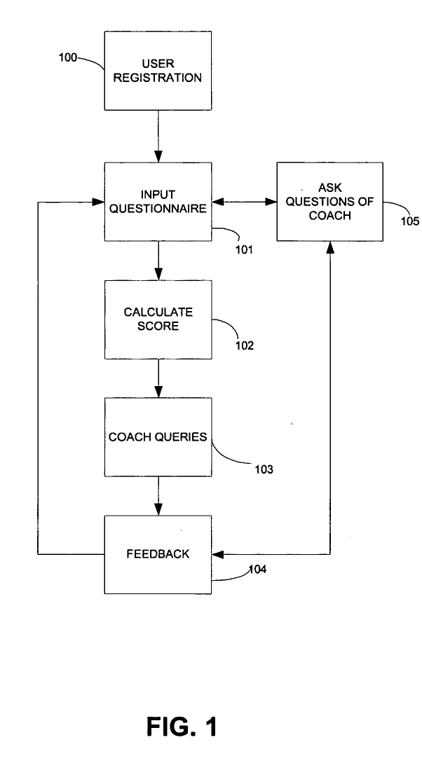

FIG. 1 is a flow diagram of the core method for interactive health assessment and tracking through weighted criteria, and for improving health, fitness and well-being by administering individually tailored feedback through personally-assigned coaches over the Internet, in accordance with the present invention.

At Step 100, a user accesses the website and is confronted with the home page and login screen prompting registered buyers to enter a login ID and password and new users to join the Life Practice^{SM} program.

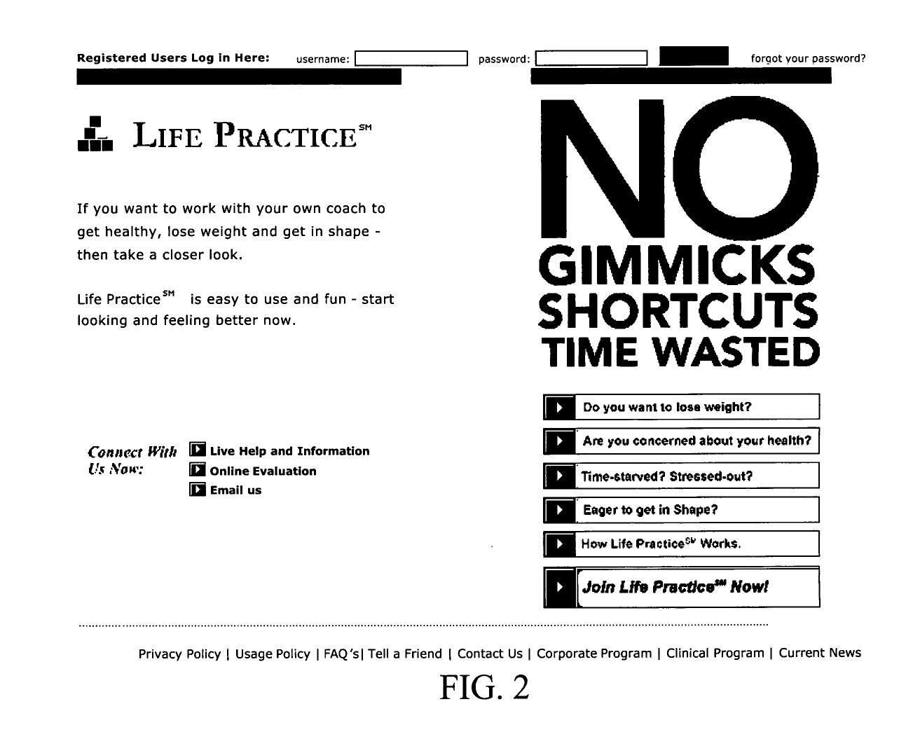

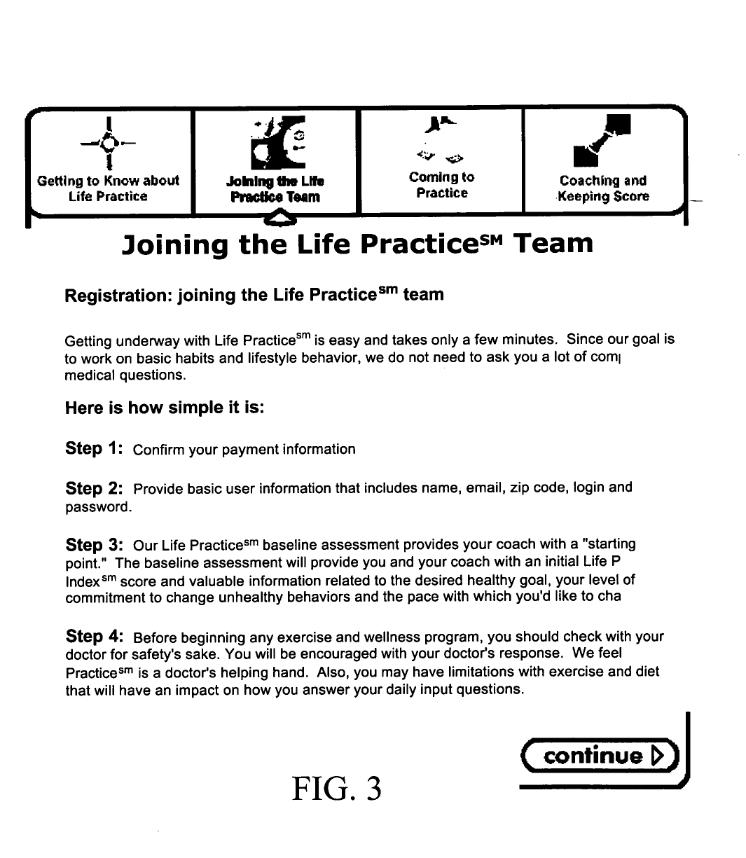

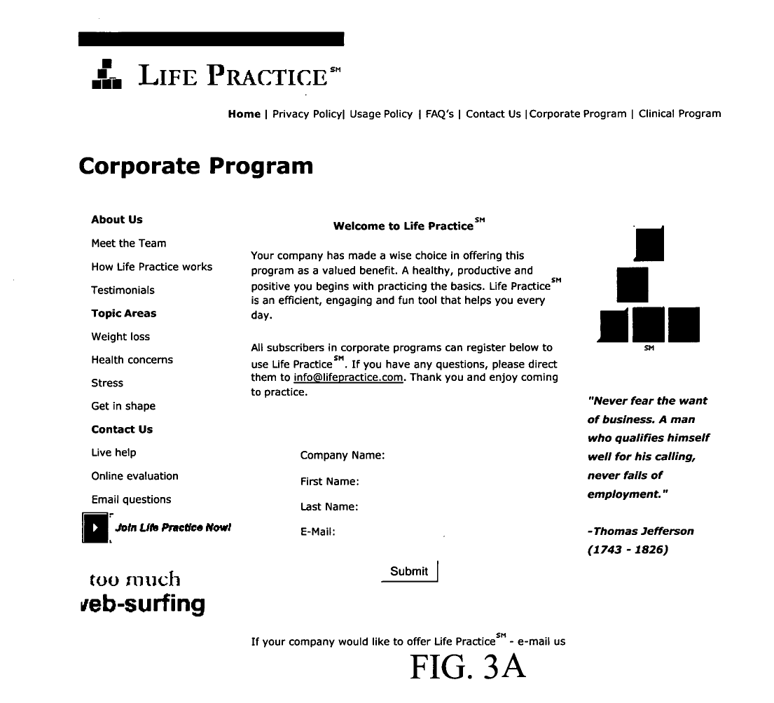

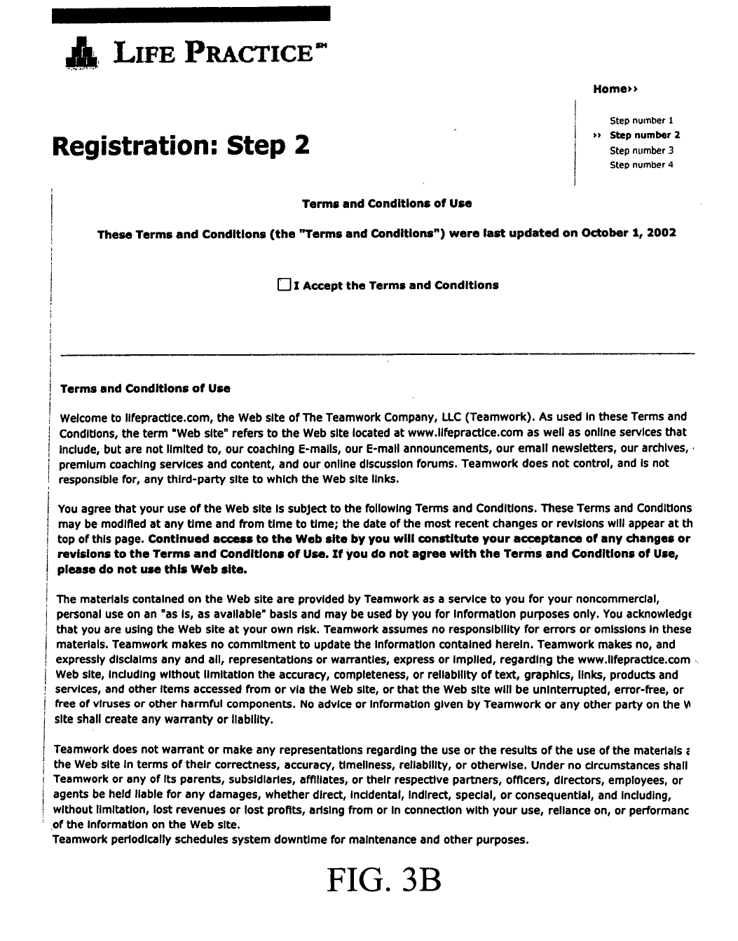

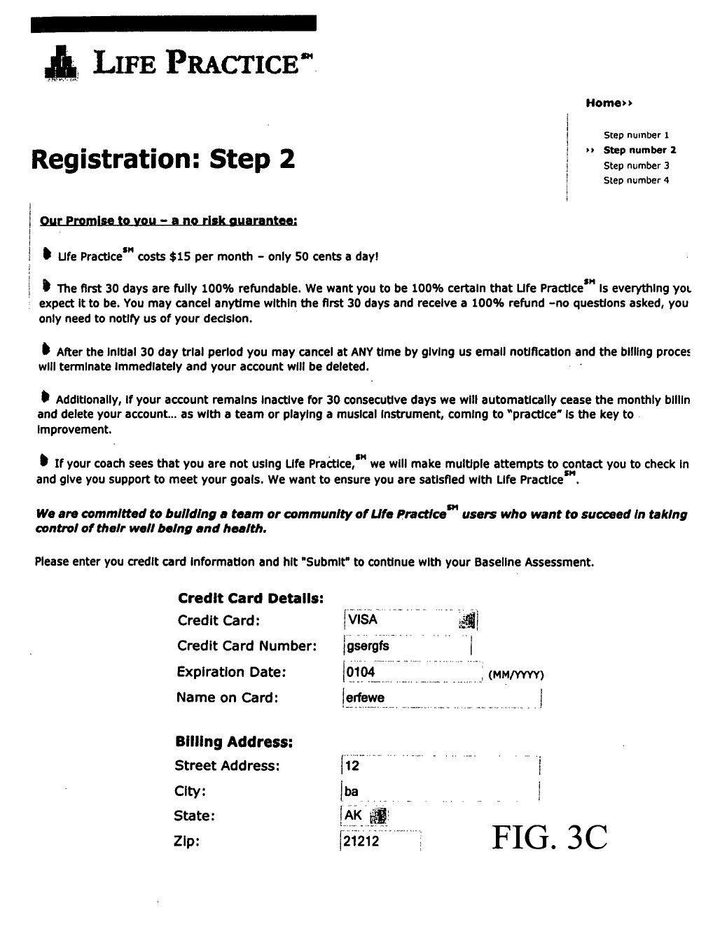

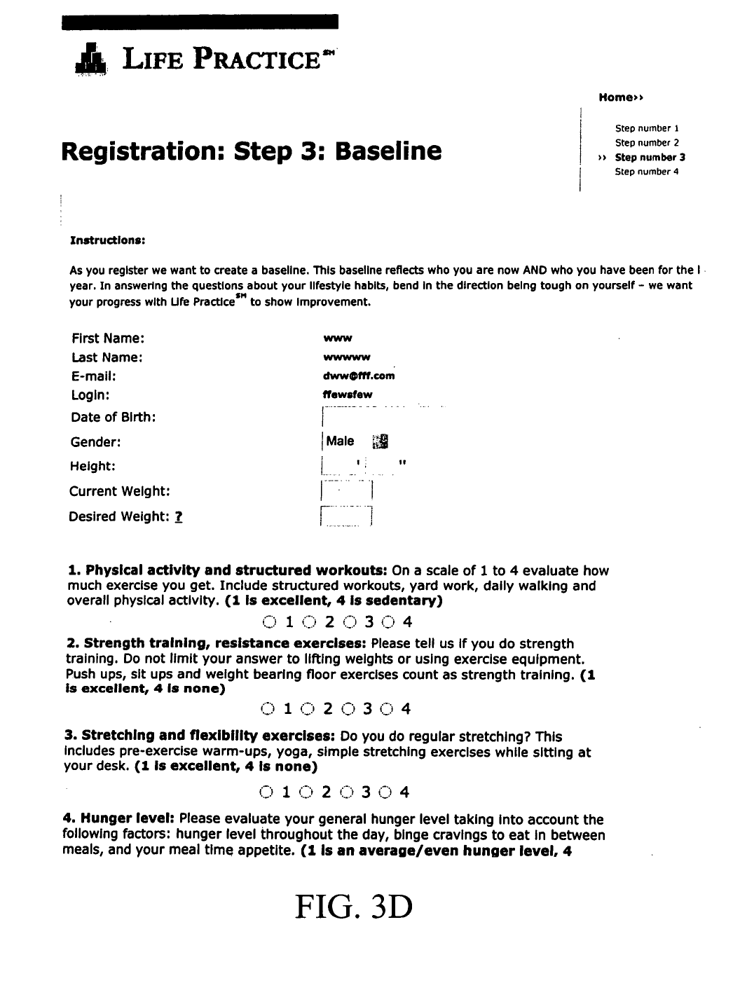

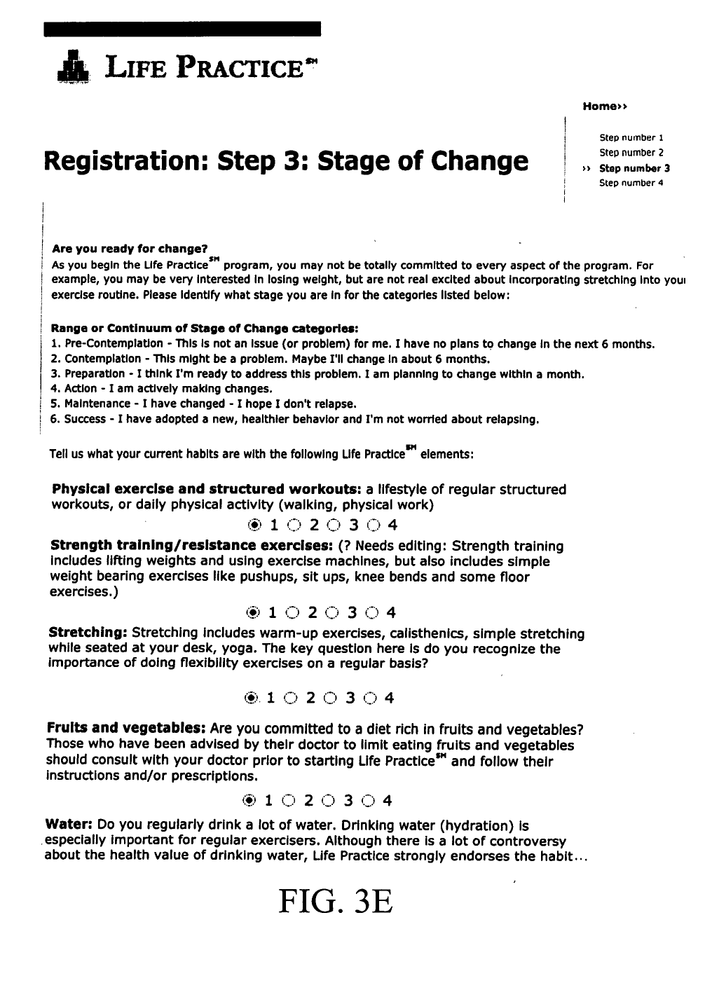

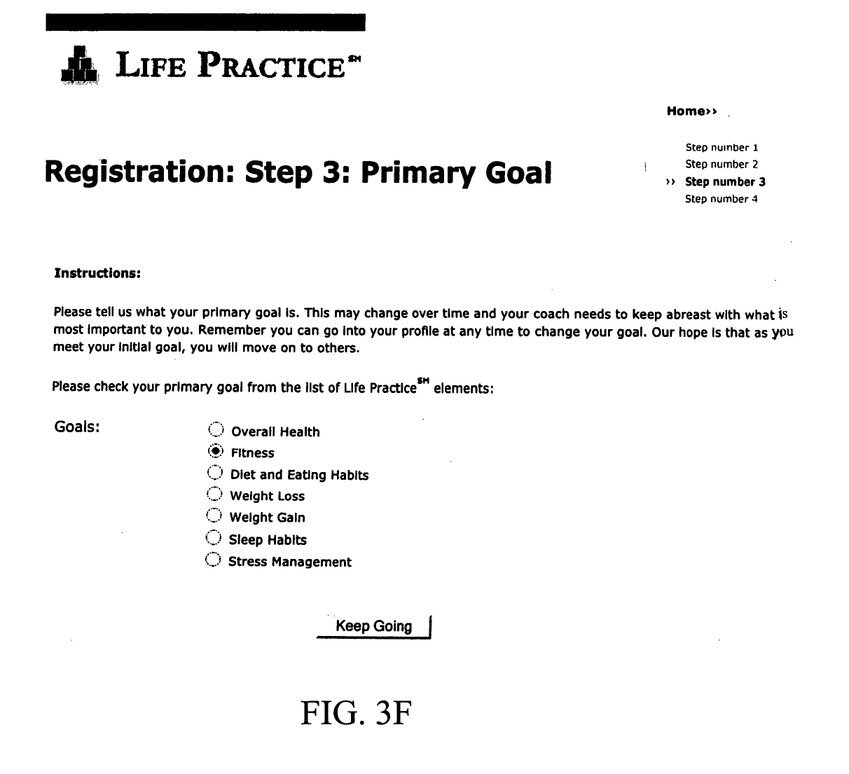

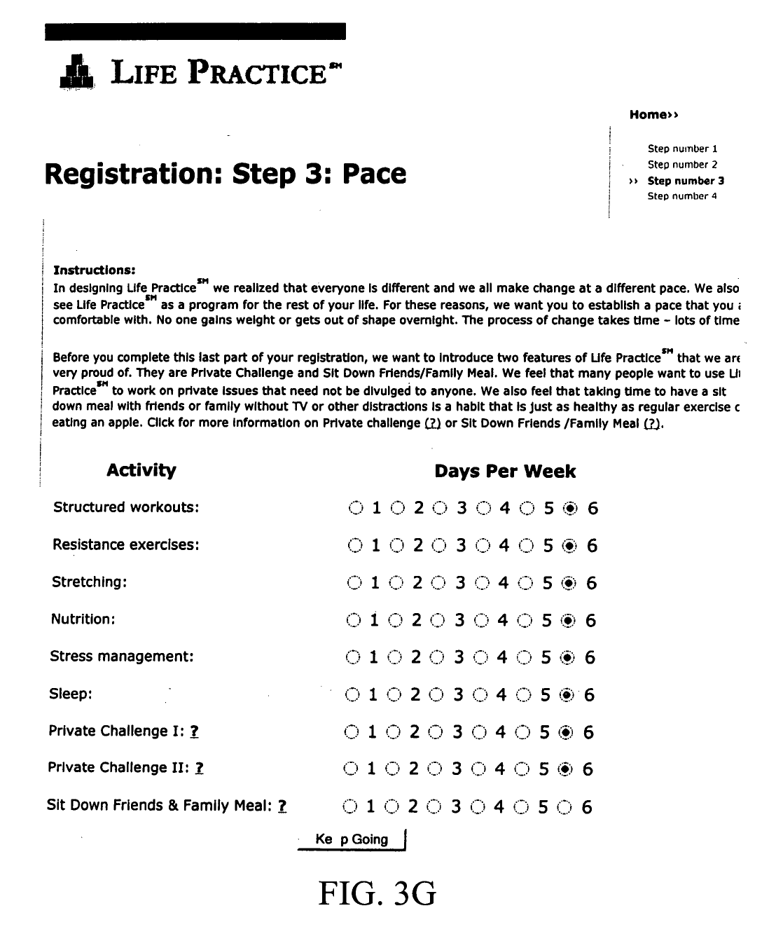

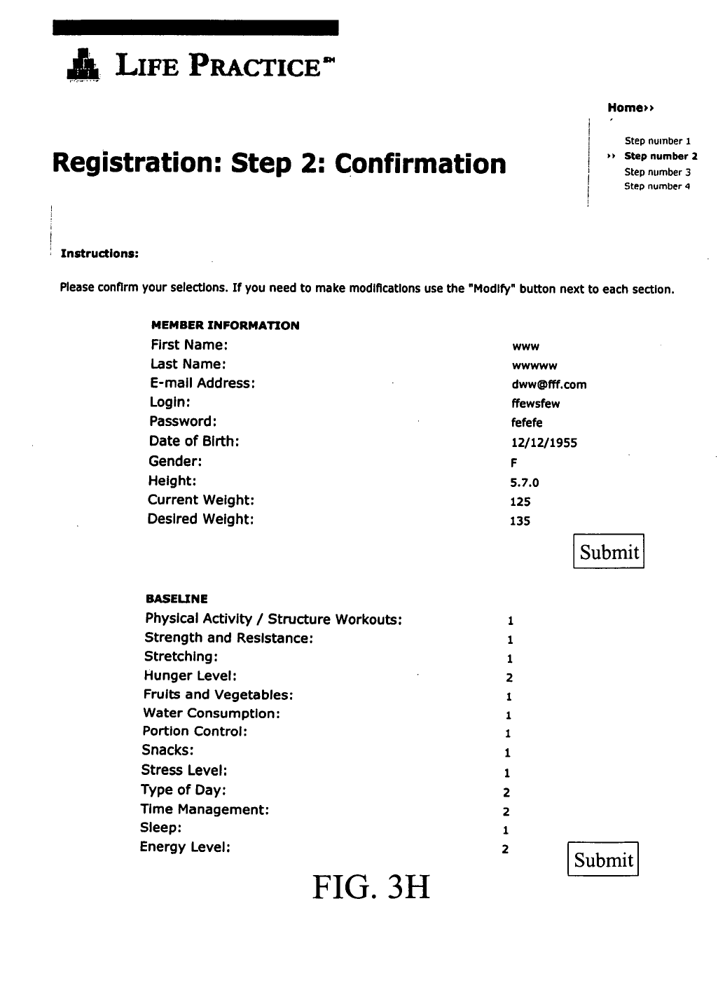

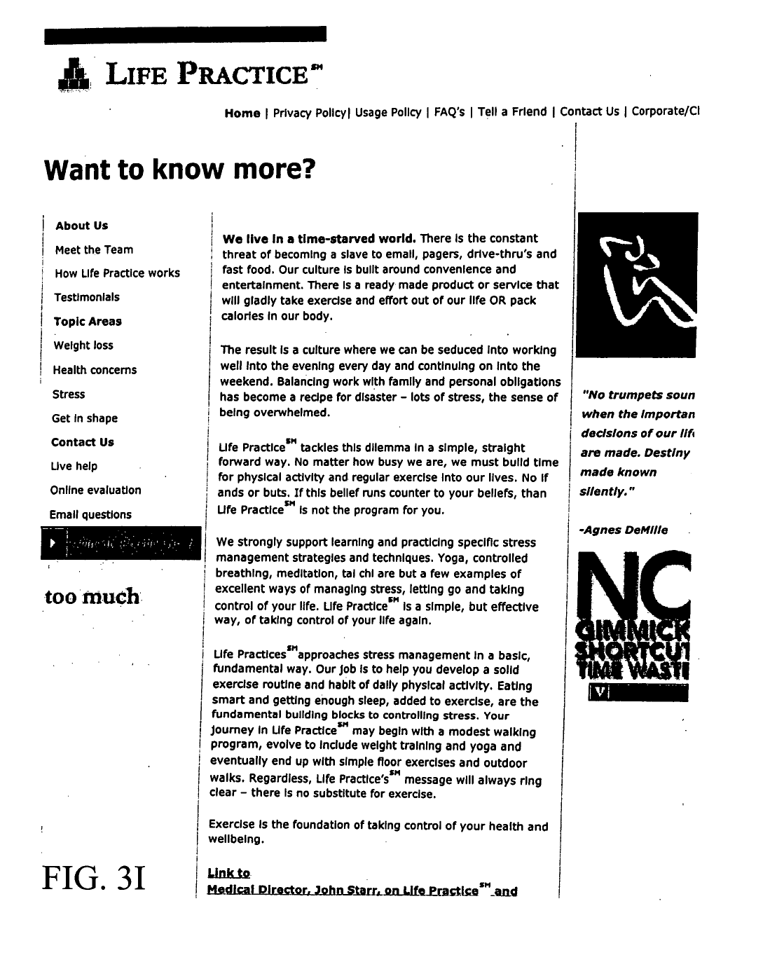

FIG. 2 is a screen print of an exemplary login screen. Unregistered buyers are prompted to sign up by clicking a “Join Life Practice^{SM} Now” button, which, when clicked on, initiates a series of screens. FIGS. 3 and 3A through 3I are exemplary screens in the registration series. The first exemplary registration screen of FIG. 3 informs the new user of the steps necessary to register to become a member of Life Practice^{SM}. After introductory information about Life Practice^{SM} registration is displayed, and the user wishes to continue, the buyer application form of FIG. 3A, inclusive of first name, last name, email address, login ID and password, is displayed. To register, the user inputs the required identification information and is also able to choose a registration timeframe (subscribers may register for 45, 60 or, really, any timeframe that is appropriate for them).

Once the identification information of FIG. 3A is validated, a Terms and Conditions screen is displayed. FIG. 3B is an example of the Terms and Conditions screen. The user is prompted to acknowledge acceptance of the terms and conditions and if the user chooses to do so, a payment screen is displayed. FIG. 3C is an exemplary payment screen. The screen displays payment terms and prompts the user for credit card and billing information. Whenever new users are registered, the initial buyer profile data is entered into the database, a purchase order is electronically transmitted to the site owner for processing and, in addition, a purchase confirmation is electronically transmitted to the buyer by email.

Referring back to FIG. 1, the new user is then prompted to complete a baseline questionnaire at Step 101. FIG. 3D is an example of the baseline questionnaire. As soon as the new member first registers, he or she completes the questionnaire which establishes a health fitness baseline assessment of the member. The questionnaire includes a particular variety of health fitness related factors. Questions are grouped by topic, and there are five requisite topics: Physical Activity, Sleep, Nutrition, Stress Management, a Private Challenge, and Sit Down Friends or Family Meal. All topics are interrelated, i.e., the topics and associated questions impact each other. For example, physical activity and nutrition impact sleep, sleep and nutrition impact stress management. Collectively and individually, the questions solicit a categorical answer in response to the topical question. The topics and exemplary questions are as follows:

Physical Activity

Questions involve the level and quality of physical activity and in particular, structured work-outs, strength training and resistance exercises, stretching and flexibility exercises.

Nutrition

Nutrition questions involve good and bad eating habits and include categories such as hunger level, fruit and vegetables, water consumption, portion control, snacks.

Sleep

The sleep questions involve overall number of hours of sleep and energy level.

Stress Management

The stress-related questions are a self-evaluation of the level of stress in the user's life and the ability to handle it.

Private Challenge

The private challenge question is meant to ensure that the user is goal setting. At initial registration the user can establish two personal challenges such as working on improving a smoking habit or eating less.

Sit Down Friends or Family Meal

The Sit Down Friends or Family Meal question is simply a yes or no question to elicit whether the user partakes in a daily family meal versus eating in front of the television.

Each of the foregoing topics, alone and in combination with the other topics, has a relative impact on health and well-being, and the user's answer to each question is assigned a particular point value. The resulting score is created based on the pre-defined elements of questions and their interrelationship. An exemplary question is: “Strength training, resistance exercises: Please tell us if you do strength training. Do not limit your answer to lifting weights or using exercise equipment. Push-ups, sit-ups and weight bearing floor exercises count as strength training. (1 is excellent, 4 is none)”. Possible answers are: 1 (point value=7.5); 2 (point value=5); 3 (point value=2.5); and 4 (point value=0).

In addition, the new user is prompted to input their Stage of Change for the various fitness categories. FIG. 3E is an exemplary Stage of Change Screen. For example, the user may already be on a diet and is therefore actively making changes in the fruits and vegetables, water, portion control, and snacks category, but has not yet begun an exercise regimen so he or she may be in the contemplation stage for exercise categories. Once the user's stages of change are input, the user is presented with a screen to input their primary personal goal, such as overall health, fitness, diet and eating habits, weight loss, weight gain, sleep habits, and stress management. FIG. 3F is an exemplary Primary Goal screen. The user is also permitted to set their own pace to meet different elements in the range of 0 to 6 days, i.e., to identify the days per week, by activity, such as structured workouts, stretching, stress management, etc., that the user will meet the requirements of a particular behavior. For example, a user might choose to do strength training three days per week and stretching five days per week. Also included in the activities are two personal challenges that the user can establish, such as working on improving a smoking habit, and a “sit down friend and/or family meal” where the user records quality time sharing meals. FIG. 3G is an exemplary Pace input screen. All questionnaire data are stored in the database and are available for queries. Once the new user completes the input to FIG. 3G, the data are validated and displayed to the user for confirmation. An exemplary Confirmation screen is shown in FIG. 3H. The user reviews the data and has the option to go back and modify any of their answers. Once the new user has confirmed their input, registration is complete.

Appearing on many of the screens, including those of FIGS. 2 and 3, is a navigable series of index tab headings and/or buttons corresponding to other sections of content available to the user, such as FAQs, Contact information, topic areas, and company information. From these screens, the user may click on a heading and the respective screen will display. For example, the “Want to Know More?” screen of FIG. 3I, is an exemplary “How Life Practice Works” screen that is presented to the user when he or she clicks on “How Life Practice Works”. The “Want to Know More?” screen is designed to present to the new or prospective user, the philosophy behind Life Practice, namely, to help bring balance to the user's life and to help improve their health. Life Practice^{SM} is not a diet, or a shortcut. Good health and well being is an investment. It takes time. The user is urged to be patient and not get discouraged if they stumble along the way, but to rely on their personally-assigned coach who will help them every step of their journey to better fitness.

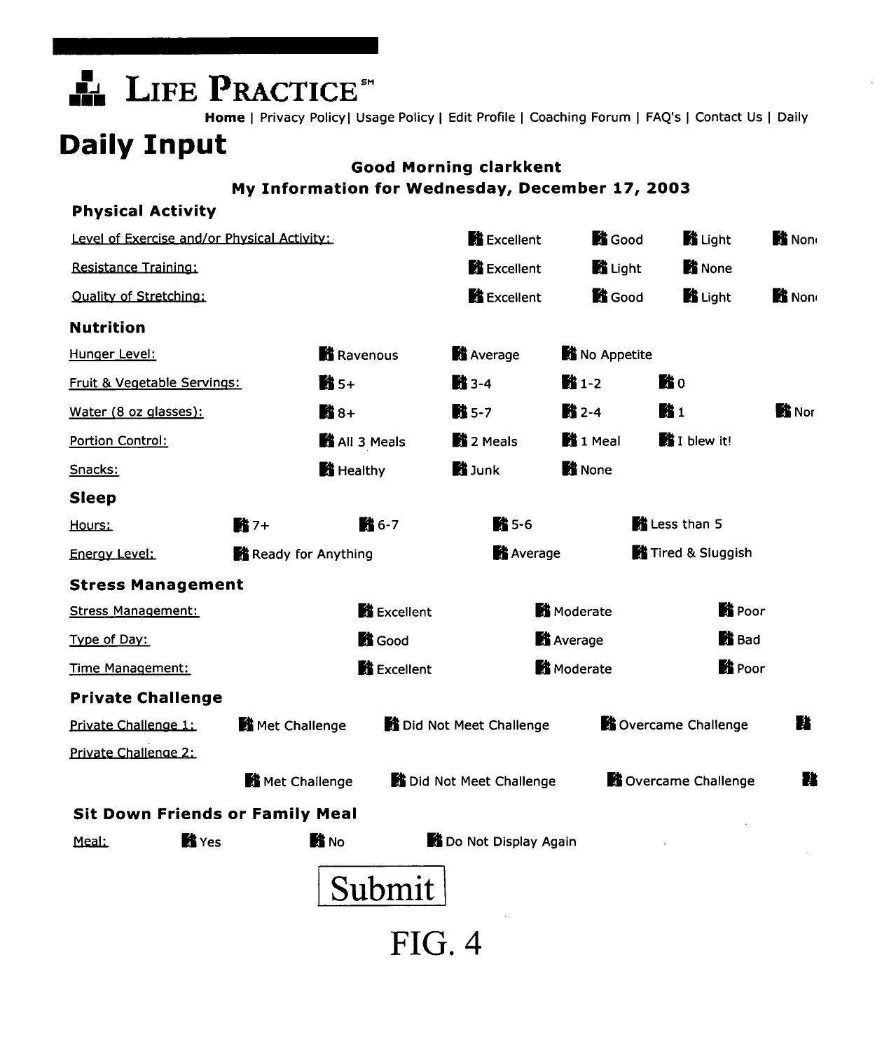

A pre-existing registered user may access the Life Practice^{SM} in one of two ways. First, he or she can access the Life Practice^{SM} website and enter their personal user ID and password on the Login Screen at Step 100. Alternatively, the user may click on the Life Practice^{SM} hot link in their daily email from their coach, which takes them to the Life Practice^{SM} Login Screen. Once the registered user inputs their personal User ID and password, the daily input screen is displayed at Step 101 for the user to answer the daily questionnaire. An exemplary daily input screen is displayed at FIG. 4. After the user completes the daily input, he or she clicks on the Submit button which initiates the calculation of the user's new Life Practice Index^{SM} (LPI)^{SM} score at Step 102 and displays the user's personal web page with the newly calculated LPI^{SM}. The personal web page displays the user's personal characteristics, LPI^{SM}, LPI history and links to reports, content and coaching forums.

Referring again to FIG. 1, at Step 102 the individual scores are calculated using weighted scoring criteria. For example, if a member answers “3” to the above-referenced strength training question, the point value of “2.5” is assigned to that criterion for calculating the individual's score, which is displayed as a Life Practice Index (LPI). An explanation of the LPI is provided for the member and as the LPI is calculated each time the member logs in to his or her personal web page and answers the applicable questions, the member can see his or her positive or negative progress. Each member's points are summed daily and the LPI is calculated based on a rolling average, i.e., the sum of the last 30 days of daily point values is divided by 30.

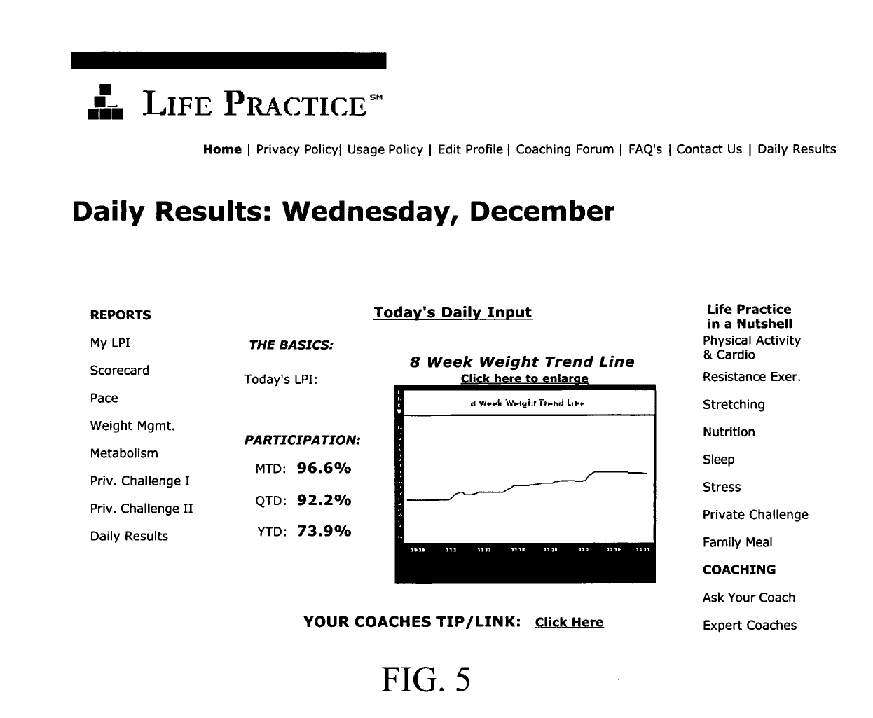

FIG. 5 is an illustration of the user's Daily Results presented following Step 102, which provides a graphical representation of the individual's LPI calculated based on a rolling average, here over the last eight weeks. As seen to the left, a number of tabs are available to allow the individual to view more detailed categorical breakdowns of the information per the five requisite topics: Physical Activity, Sleep, Nutrition, Stress Management, a Private Challenge, and Sit Down Friends or Family Meal.

The screen of FIG. 5 also reflects a link to the individuals coach. One of the primary advantages of the present method is the administration of personally-assigned coaches who motivate the users. Referring again to FIG. 1, at Step 103, coaches log on to the Coaches Console which provides them with a suite of software tools that allows them to generate tiered-queries to selected groups of users, including: Pre-season (members in the first 30 days of the Program), Tier 1 (members any time after the first 30 days of the Program), or Tier 2 (Milestone) levels. The Coaches Console is described in more detail in FIG. 2. If any member assigned to the Coach meets the criteria for a query, the results are displayed to the coach. The coach then clicks on a specific query title, to generate personalized email to the members who have met that criteria at Step 104. The emails are personally tailored by the coach addressing the positive or negative aspect of the query result. All members assigned to a specific coach may participate in a forum with the coach and the other members assigned to the respective coach, i.e., the team, whereby they may ask questions of the coach and each other, as well as post topical information and discussion triggers. At Step 105, the individual members participate in the forum where they can ask questions of their assigned coach who responds by providing feedback to the member via email at Step 104. Steps 101 through 105 are repeated daily or as often as the member logs on and inputs answers to the questionnaire.

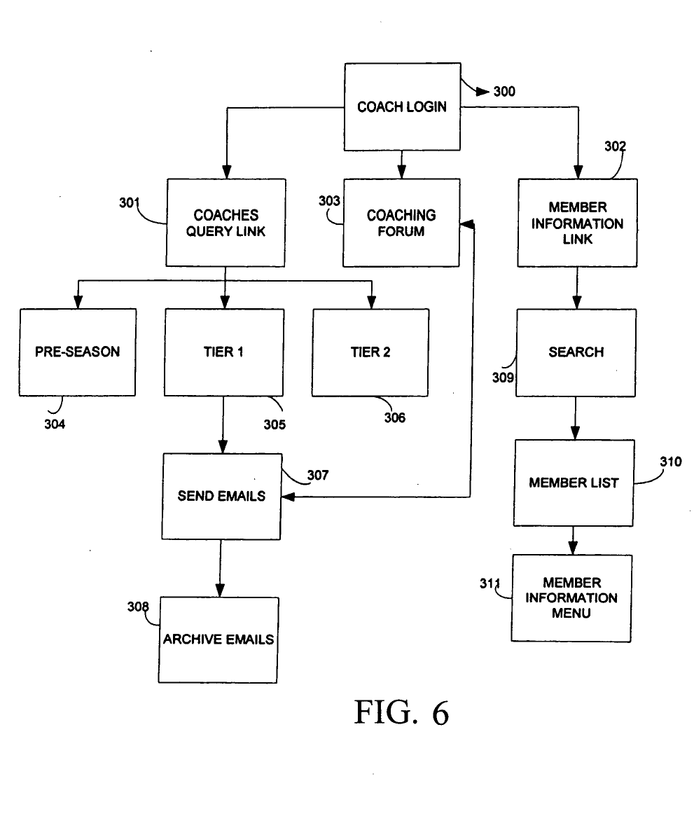

FIG. 6 is a flow diagram of the Coaches Console according to the present invention. The Coaches Console is available to all coaches. Multiple coaches are assigned to many specific members. At Step 300 the coach logs in with user name and password. The user table provides the security to identify the user name as a coach and the coach will be automatically linked to the coaches console. From there, the coach may either link to the Coaches Queries at 301, the Member Information at 302, or the Coaching Forum at 303. If the coach selects the Coaches Queries 301, the coach will be presented with a choice of three links, Pre-Season at 304, Tier 1 at 305 or Tier 2 at 306. Pre-season represents the member's first 30 days in the Program, Tier 1 represents any time after the member's first 30 days in the Program, and Tier 2 represents Milestones. Collectively, in all three links, more than 100 simple and compound pre-defined queries are stored. Appendix A is a printout of all of the pre-defined queries. After the coach selects a tier-link and employs a given query, a page will be displayed with a list of any query titles where members have met the criteria of that specific query. For example, under the Pre-season link, the following query titles may appear:

Day 1: Good Score (daily LPI score>or=60)

Day 2: Some Exercise (Average General Activity>or=25 OR Average Structured

Workout>or=10 minutes)

Day 4: No Exercise (CVE*<or=10 and Stretching=0 and Resistance=0 for each of the last 4 days)

*CVE—Cardiovascular Exercise

Day 12: Poor Sleep (Average Sleep<or=9)

Day 16: Good Exercise and Weight Loss ([(Average CVE score+Average Stretching+Average Resistance)>or=30] AND weight<previous week's weight)

Examples of Tier 1 query titles include:

Good LPI Score (Daily LPI Score>or=60 (3 consecutive days)

Bad Exercise and Portion Control for Straight 4 Days ([Average Daily Point Value for CVE+Average Daily Point Value for Resistance+Average Daily Point Value for

Stretching<or=20] and [Cumulative Daily Points for Portion Control<or=8 for last 4 days])

Good Water (Water=7.5 for 3 consecutive days)

Examples of Tier 2 query titles include:

Days of Exercise in a one year period. Calculated from start date—every year the clock restarts on anniversary date.

Exercise defined as:

(Medium or High General Activity) or

(Structured Activity>0) or

(Resistance>0) or

(Stretching>0).

By clicking on one of the query titles, at Step 307, the coach will be presented with text boxes wherein he or she may enter the subject and body of an email. When the coach clicks on the “Send Email” button, the Email is sent to everyone they coach who met the criteria of the query. In addition, general Head Coach and user-wide broadcast information, reminder and congratulation emails are sent to all qualifying members. At Step 308, the Emails are archived.

If the coach clicks on the Member Information at Step 302, the coach is presented with a search screen at Step 309 whereby the coach can search for a specific member. The coach enters the search criteria and is presented with a list of members that meet the criteria at Step 310. By clicking on the selected member, the coach is presented with the Member Information Menu at Step 311. The menu includes the user's daily web page, user profile, user reports, forum participation, coaching email archive, and historical data screens.

By clicking on the Coaching Forum link at 303, the coach enters the Coaching Forum. The forum provides an effective mechanism for the coach to communicate with his or her team members and vice versa. In the forum environment, participating team members may ask questions of the coach or other team members, as well as post discussion topics and topical items of interest.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for expert health coaching of individuals to improve their health, fitness and wellness through interactive Internet access, comprising:
(a) generating periodic electronic prompts on the remote computers of individuals to complete a comprehensive questionnaire on a variety of health behaviors;
(b) collecting and storing the individual's responsive input data in a database;
(c) calculating a periodic score based on the input data and weighted criteria;
(d) tracking the user's periodic scores over time; and
(e) providing personal electronic feedback to the remote computers of said individuals users on a periodic basis.

2. The method for expert health coaching of individuals according to claim 1, wherein said comprehensive questionnaire comprises topical questions including at least four requisite topics: Physical Activity, Sleep, Nutrition, Stress Management, and Sit Down Meal.

3. The method for expert health coaching of individuals according to claim 2, wherein said comprehensive questionnaire comprises a fifth topic comprising questions relating to a personal challenge to ensure that the user is goal setting.

4. The method for expert health coaching of individuals according to claim 3, wherein an individual's answers to said questionnaire are assigned a particular point value, and said calculating step comprises multiplying each point value by a weighted score dependant on topic and question, and by compiling the weighed point values over time into a rolling average overall life practice index.

5. The method for expert health coaching of individuals according to claim 4, wherein the daily weighted score and rolling average life practice index is displayed to each user each time they respond to one of said electronic prompts.

6. A method for expert health coaching of individuals to improve their health, fitness and wellness through interactive Internet access, comprising:
(a) generating daily electronic prompts on the remote computers of individuals to complete a comprehensive questionnaire on a variety of health behaviors;
(b) collecting and storing the individual's responsive input data in a database;
(c) calculating a daily score based on the input data and weighted criteria;
(d) tracking the user's daily scores over time; and
(e) providing personal electronic feedback to the remote computers of said individuals users on a daily basis.

7. The method for expert health coaching of individuals according to claim 6, wherein said comprehensive questionnaire comprises topical questions including at least four requisite topics: Physical Activity, Sleep, Nutrition, Stress Management, and Sit Down Meal.

8. The method for expert health coaching of individuals according to claim 7, wherein said comprehensive questionnaire comprises a fifth topic comprising questions relating to a personal challenge to ensure that the user is goal setting.

9. The method for expert health coaching of individuals according to claim 8, wherein an individual's answers to said questionnaire are assigned a particular point value, and said calculating step comprises multiplying each point value by a weighted score dependant on topic and question, and by compiling the daily weighed point values over time into a rolling average overall life practice index.

10. The method for expert health coaching of individuals according to claim 9, wherein the daily weighted score and rolling average life practice index is displayed to each user on a daily basis.

11. A system for expert health coaching of subscribers to improve their health, fitness and wellness through interactive Internet access, comprising:
(a) subscriber registration and validation software;
(b) at least one online questionnaire form for prompting subscribers to input personal health fitness information on a periodic basis;
(c) a database for storing the periodically-entered personal health fitness information;
(d) a ranking module for ranking the cumulative health fitness information of members and for compiling progress;
(e) a coach management module for allowing personal trainers to identify subsets of members who attain various positive or negative milestones and to generate electronic communications to those subsets sets that address the positive or negative milestone.
